(19) United States
(12) Patent Application Publication
(10) Pub. No.: US 2010/0306344 A1
(43) Pub. Date: Dec. 2, 2010

(54) Methods and Systems for Using Multipart Messaging with Preset Constraints

(75) Inventors: Gregory J. Athas, Lisle, IL (US); Michael J. Zabramski, Yorkville, IL (US); Cesar Moreno, Forest Park, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Nokia Corporation, Espoo (FI)

(21) Appl. No.: 12/755,101

(22) Filed: Apr. 6, 2010

Related U.S. Application Data
(60) Provisional application No. 61/166,944, filed on Apr. 6, 2009.

(51) Int. Cl. G06F 15/16

(52) U.S. Cl. 709/219

(57) ABSTRACT

A system and method for using multipart messaging with preset constraints is provided. A device sends a request to a server for information from a website. The server retrieves the information and looks for referenced subdocuments, e.g., images. The server requests the images one-by-one from servers for a predetermined amount of time, or until a predetermined amount of content has been retrieved. Once the limit has been met, the server attaches the images to the document and sends the information to the device. Thus, the server may send a portion of the requested information to the device. The device then sends subsequent page requests for any information that was not received from the server. Using this system, the device can receive a faster first impression of the web page, without a performance delay waiting for all images of the web page to be retrieved and loaded.

### CROSS REFERENCE TO RELATED APPLICATION

The present patent application claims priority to U.S. Provisional Patent Application Ser. No. 61/166,944, filed on Apr. 6, 2009, the entire contents of which are incorporated herein by reference as if fully set forth in this description.

### FIELD

The present application relates generally to the field of web browsing and network communications. More specifically, the application relates to a system and method for delivering information from web pages to devices, such as a cellular telephone or personal digital assistance (PDA). Further, the application applies to real-time aggregation of content, for example.

### BACKGROUND

Today, many worldwide web pages (HTML documents) are available that offer an abundance of viewable images. Computers use client browsers to assist a user in viewing and navigating the web pages. To view a web page, for example, the client browser will make a request (HTML request) for information from the web page to a server. The server will, in turn, retrieve the information and will parse the information to look for images that are referenced. The server will then request the images one by one from corresponding image servers. Once all of these requests are completed, the server will send a package including the information from the request and also containing the byte data for all the images that are used in the information to the browser. Thus, the device sends one request and the server sends one response including all information. This avoids having the device establishing multiple connections to the server, and may be referred to as multipart messaging.

Multipart messaging includes retrieving a single document that includes many pieces in response to one request. This is in contrast to non-multipart messaging, for example, which includes sending multiple requests for all pieces of a document (e.g., each image requested separately). Using multipart messaging, the server receives fewer requests, and the client browser receives all information and images at once. The server will retrieve the information from a website and any associated images, combine all into a single document, and send the single document to the client browser. Multipart messaging helps to solve problems associated with slow networks where multiple requests lead to inefficiencies.

Multipart messaging may provide a faster delivery mechanism than non-multipart delivery, for example. A total load time may be faster, however, a first impression time (e.g., time to see something on a screen, such as the navigation bar or any text) may be slower due to the server retrieving all information at once. For example, the server needs to wait until all images have been retrieved from a content server before the server can send the multipart response to the device. If there are too many images in the page being served, or if some of the images are too large, or simply if the content server is slow to respond, the server might end up waiting a long time to retrieve all the images before the server can send a response to the device.

### SUMMARY

In one embodiment, a method for delivering information content to a device is provided that includes receiving a request from a device for information content from a webpage, and retrieving a document associated with the webpage that includes references to subcomponents. The method also includes based on a constraint, requesting from a content server a partial set of the subcomponents referenced by the document, and sending the document and the partial set of the subcomponents received from the content server to the device in a single response.

In another embodiment, a computer readable medium having stored therein instructions executable by a computing device to cause the computing device to perform functions is provided. The functions include receiving a request from a device for information content from a webpage, and retrieving a document associated with the webpage that includes references to subcomponents. The functions also include based on a constraint, requesting from a content server a partial set of the subcomponents referenced by the document, and sending the document and the partial set of the subcomponents received from the content server to the device in a single response.

In still another embodiment, a server is provided that includes a processor and memory including machine language instructions executable by the processor to perform functions comprising receiving a request from a device for information content from a webpage, retrieving a document associated with the webpage that includes references to subcomponents, and based on a constraint, requesting from a content server a partial set of the subcomponents referenced by the document. The server also includes a normalizer for transcoding the document and the partial set of the subcomponents received from the content server into a format displayable on the device. The normalizer may also send the transcoded document and the partial set of the subcomponents to the device in a single response.

These and other aspects will become apparent to those of ordinary skill in the art by reading the following detailed description, with reference where appropriate to the accompanying drawings. Further, it should be understood that the embodiments noted herein are not intended to limit the scope of the invention as claimed.

### BRIEF DESCRIPTION OF THE DRAWINGS

FIG. 1 is a block diagram illustrating an example system for accessing, adapting, and presenting information content to electronic devices.

FIG. 2 illustrates a message flow diagram showing one example of a method for delivering information to devices using multipart messaging.

FIG. 3 is a flowchart detailing an example method for image retrieval.

FIG. 4 is an example flow diagram illustrating a method for delivering information to devices using smart multipart messaging.

FIG. 5 is a flowchart depicting one example of a method of smart multipart messaging.

FIG. 6 is a flowchart illustrating another example method for delivering information to devices using smart multipart messaging where a threshold is a time limit.

FIG. 7 is a block diagram of an example computing device that may operate according to example embodiments, such as to perform smart multipart messaging or real-time aggregating of content into a single multipart response.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and are made part of this disclosure.

The present application provides systems and methods for delivering information from web sites to devices for display. A device may send a request to a server for information from a web site. The server will then retrieve the information and will parse the information to identify images that are referenced in a document. The server will then request the images one by one (or in groups) from corresponding image servers. The server will continue to do so for a predetermined amount of time, until a predetermined amount of content has been retrieved, or until a threshold has been reached with respect to time, data, requests, or any combination thereof, for example. Once the limit on time or size has been met, for example, the server will attach the images to the document and send the information to the device. The server may transcode the information prior to sending the information to the device. Thus, the server will possibly only send a portion of the requested information to the device (if not all information could be retrieved within the time window or if not all information is within the size limit, for example). The device may then send subsequent page requests for any information that was not received from the server. Using these systems and methods, the device may receive a faster first impression of the web page without a performance delay waiting for all images of the web page to be retrieved and loaded, for example.

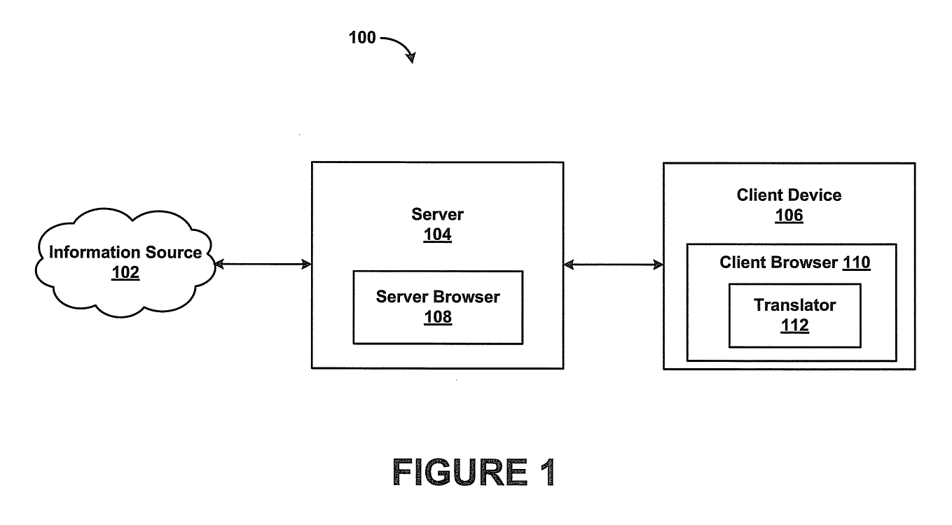

Referring now to FIG. 1, a high-level diagram is shown illustrating an exemplary system 100 for accessing, adapting, and presenting information content to electronic devices. The system 100 includes an information source 102, a server 104 and a client device 106.

The information source 102 includes any type of device such as a web server, application server, database or other backend system, or any interface to an information provider. The information source 102 may further comprise multiple devices or interfaces that enable connection to information content. The information source 102 provides information content expressed in a markup language, such as, for example, those markup languages known in the art including Hypertext Markup Language (HTML), Extensible Markup Language (XML) with or without Extensible Style Sheets (XSL), VoiceXML, Extensible Hypertext Markup Language (XHTML), Wireless Markup Language (WML), or other types of languages as can be processed by the client device 106. Furthermore, the information content can reference text, images, video, or audio information to be provided by the information source 102. The information content may be a website or web page, or multiple web pages, for example.

The information source 102 can be accessed through any type of network by the server 104 via a server browser 108. The server browser 108 may communicate with the client device 106 over any type of network through a client browser 110. The server browser 108 may perform as a proxy between the client browser 110 and the information source 102 for web page content for viewing. The server browser 108 may operate as a client of the information source 102 to retrieve the information content. For example, using a known suite of communications protocols such as Transmission Control Protocol/Internet Protocol (TCP/IP), the server browser 108 can issue a Hypertext Transfer Protocol (HTTP) request to the information source 102. By utilizing HTTP requests, the server browser 108 can access information content, including applications, static, and dynamic content at the information source 102.

The server browser 108 and the client browser 110 may reside on the same platform or may be separate from each other. For example, the server browser 108 might be hosted on a back-end server, and the client browser 110 might be hosted on a hand-held electronic device, as shown in FIG. 1. Alternatively, the client device 106 and the server 104 may co-exist on the same device, and thus, functionality of either can be substituted by each other. For example, the server browser 108 and client browser 110 can be hosted on the same platform such as on an electronic device, if the platform or electronic device has the appropriate hardware and network capabilities. Thus, within many embodiments herein, functionality may be described as being part of the client browser 110 or as being part of the server browser 108. The client browser 110 may perform functions explained as being performed by the server browser 108, and the server browser 108 may perform functions explained as being performed by the client browser 110. By utilizing the server and client browser, electronic devices with limited hardware capability can access feature rich information or data.

Generally, the server 104 and the client device 106 include a central processing unit, a memory (a primary and/or secondary memory unit), an input interface for receiving data, an input interface for receiving input signals from one or more input devices (for example, a keyboard, mouse, etc.), and an output interface for communications with an output device (for example, a monitor). In general, it should be understood that the server 104 and the client device 106 could include hardware objects developed using integrated circuit development technologies, or yet via some other methods, or the combination of hardware and software objects that could be ordered, parameterized, and connected in a software environment to implement different functions described herein. Also, the hardware objects could communicate using electrical signals, with states of the signals representing different data. It should also be noted that the server 104 and the client device 106 may generally execute application programs resident at the server 104 and the client device 106 under the control of an operating system. The application programs, such as the server browser 108 and the client browser 110, may be stored on memory within the server 104 and the client device 106 and may be provided using machine language instructions or software with object-oriented instructions, such as the Java programming language. However, other programming languages (such as the C++programming language for instance) could be used as well.

As an example, the client browser 110 may reside on the client device 106, which may be an electronic device including any of a personal computer (PC), wireless telephone, personal digital assistant (PDA), hand-held computer, network appliance, and a wide variety of other types of electronic devices that might have navigational capability (e.g., keyboard, touch screen, mouse, etc.) and an optional display for viewing downloaded information content. Furthermore, the client device 106 can include any type of device that has the capability to utilize speech synthesis markups such as the World Wide Web Consortium (W3C) Voice Extensible Markup Language (VoiceXML). One skilled in the art of computer systems will understand that the example embodiments are not limited to any particular class or model of computer employed for the client device 106 and will be able to select an appropriate system.

Within the example, the client browser 110 resides on the client device 106, and also a PC hosts the server browser 108, and the client device 106 and PC are both connected to an Ethernet network. Then, the client browser 110 and the server browser 108 could perform information transactions over the Ethernet network. Such transactions would utilize Ethernet or similarly IEEE 802.3 protocols. Nevertheless, in this example, the client and server browsers communicate over a wired network. The communications might also include a wireless network such as a local area wireless network (LAWN), a wireless local area network (WLAN), or a cellular wireless network. Moreover, the communications might include wireless networks that utilize other known protocols and technologies such as Bluetooth, wireless application protocol (WAP), time division multiple access (TDMA), or code division multiple access (CDMA).

Referring again to FIG. 1, the client browser 110 can send a request for information to the server browser 108. The client browser 110 may include an event translator 112 to convert a request/response protocol, such as an HTTP request, from the client browser 110 (e.g., WML, XHTML, cHTML, etc.) to an event that the server browser 108 recognizes. The translation process could include event information, content information, and the context of the event such that transactions between the client browser 110 and the information source 102 (e.g. HTML form submission) are preserved.

Information content from the information source 102 is retrieved and can be tailored for use on the client browser 110 by the server browser 108. Alternatively, the server browser 108 may retrieve the information and send the information to the client browser 110, which itself tailors the information appropriately for viewing. Content transformations may be necessary since the requested content (e.g., a web page) could have been initially designed for viewing on a large screen of a PC, rather than on a limited screen size of a hand-held device. As a result, either the server browser 108 and/or the client browser 110 can perform information content rendering transformations or apply device specific style sheets to aid in presentation (e.g., display or voice) and navigation (e.g., keyboard, touch screen, or scrolling), and perform content grouping for electronic devices that accepts data in limited quantities.

To deliver these capabilities, the server browser 108 or client browser 110 may include modules (not shown) including a user agent, cookie handler, document object model (DOM), script executor, normalizer, and serializer, for example. Additional information pertaining to information content transformation or customization is included in U.S. Pat. No. 7,072,984, entitled “System and method for accessing customized information over the internet using a browser for a plurality of electronic devices,” U.S. Patent Application Publication No. 2004/0049737, entitled “System and Method for Displaying Information Content with Selective Horizontal Scrolling,” U.S. Pat. No. 7,500,188, entitled “System and Method for Adapting Information Content for an Electronic Device,” U.S. Patent Application Publication No. 2007/0073777, entitled “System and Method for Web Navigation Using Images,” and U.S. Patent Application Publication No. 2008/0195692, entitled “Method and System for Converting Interactive Animated Information Content for Display on Mobile Devices,” the contents of each of which are incorporated herein by reference as if fully set forth in this description.

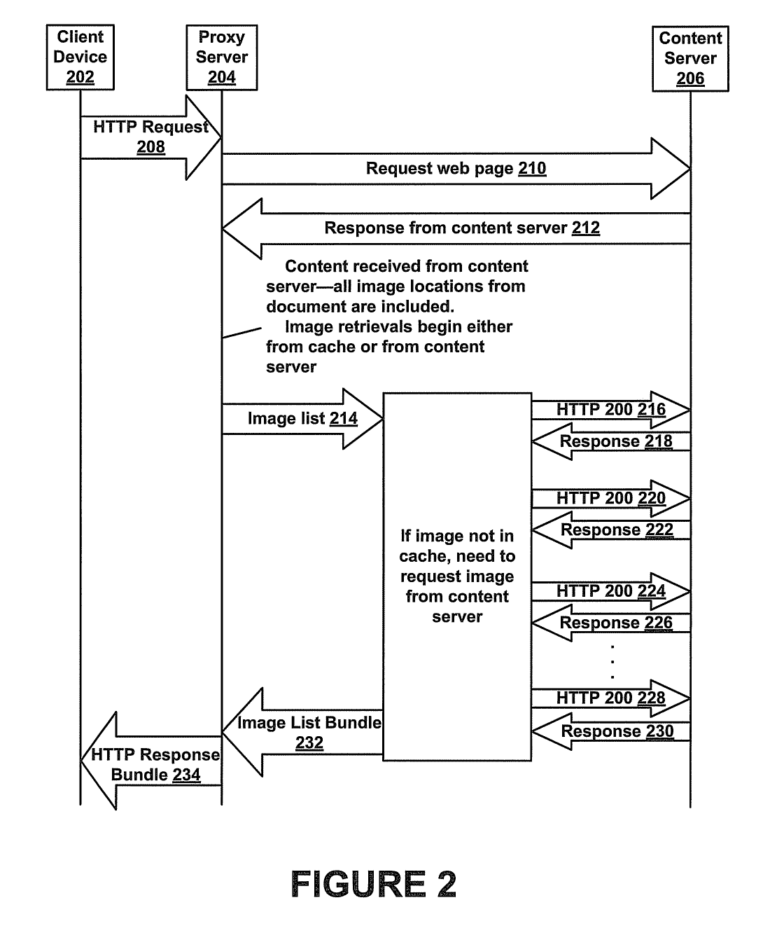

The system 100 includes software (within the client device 106 or the server 104) for delivering information from web sites to devices for display. FIG. 2 illustrates a message flow diagram showing one example of a method for delivering information to devices using multipart messaging. Initially, a client device 202 will make an HTTP request 208 for a website to a proxy server 204, which requests the website from a content server 206, for example, as shown by request 210. The proxy server 206 receives a response 212 including content from the content server 206 (in this example, no re-directions, post requests, credentials requests, or any response other than an HTTP 200 message is shown, although all of these requests will follow the same logic once an HTML document is received by the proxy server 204). The proxy server 204 will identify subcomponents of the HTML document, such as images, media files, Javascript, and the proxy server 204 will also collect sources of the subcomponents from the HTML document to create a collection of objects.

The proxy server 204 will then retrieve the subcomponents of the HTML document. In this example, if the HTML document includes images, the proxy server 204 may determine if the images have been previously cached or stored. For example, if an image has been previously requested by another client device, the proxy server 204 will have already requested the image and possibly have stored the image in cache. Thus, the proxy server 204 will send an image list 214 to a database, or check a database for images on the image list 214. If the images were not cached, the proxy server 204 then will retrieve the images from the content server 206, as shown using requests and responses 216-230. For example, a first image requested from the content server 206 may be returned using an HTTP 200 message sent to the proxy server 204. However, if an image request fails, an HTTP 400 message may be sent to the proxy server 204, and image retrieval continues. If the image request fails again, an HTTP 408 message (HTTP Time Out) can be sent to the content server 206. Once all images are retrieved, as shown by message 232, the images may be bundled and added to a response 234 by the server 206, and sent back to the client device 202 with the images data.

The response 234 may be a multipart response message indicating that the message include multiple parts (e.g., the HTML document and subcomponents referenced in the HTML document). There are multiple multipart modes in which a device may operate. If a device supports multipart responses, the device also supports image bundling. When such a device makes a request to the server, the server will return the HTML content, and then depending on a multipart mode (e.g., related, mixed), the server will send the images one by one, or the server will send a bundle of images with the original multipart response. Thus, when a device makes a request to the server for a website, if multipart is enabled, there may be only one connection open between the device and the server. If the same device makes the same request to the same server and multipart is disabled, the device will open one connection with the server to request the root HTML document, and the server will send the HTML content to the device, which will then have to open another connection to the server for every subcomponent referenced in the HTML document (e.g., every image included in the HTML code).

In the example flow diagram of FIG. 2, multipart is enabled, and the HTML document and all subcomponents referenced in the HTML document are returned to the client device 202 in one response message 234. When multipart messaging is enabled, embodiments of the present application may use portions of a multipart messaging protocol as described in RFC 2387, “The MIME Multipart/Related Content-type”, the entire contents of which are incorporated herein by reference. Multipurpose Internet Mail Extension (MIME) multipart messages define how multiple data parts can be included within a single message. The data parts can be text files, HTML documents, or binary data (such as images), where the multipart specification defines how the data parts are combined together, as well as how binary data are encoded within the message, for example. By supporting MIME Multipart, an amount of time to load a complex web page into a mobile handset can be reduced, for example.

In a multipart message, the different parts are placed into a single message, one after the other, separated by a divider. The divider or boundary may be a text string defined in a MIME multipart content-type header field that precedes the entire message. For example, for the multipart/mixed content-type (which refers to a multipart message containing a collection of unrelated parts of various types), a general form for the content-type field is:

Content-Type: multipart/mixed; boundary=separatorstring

The “separatorstring” is a string of characters, which may be guaranteed never to appear elsewhere in the message, and is used to separate the message parts. Boundaries between message parts can be simple text lines including the string “--separatorstring”, that is, the boundary string proceeded by two dash characters. This string is followed by the content-type declaration for the specific part, which is in turn followed by a blank line, containing only a carriage return/line feed (CRLF), to indicate the end of the headers and the start of the data. The end of one part of the data, and the beginning of the next part, is indicated by another string of the form “--separatorstring”. The end of the entire message is marked by a special string that is identical to the separtorstring that indicates the boundaries between message parts, with the addition of two more hyphens at the end of the line: “--separatorstring--”.

The following example outlines such a message, where the strings CRLF denote the blank lines that follow the headers and precede the data:

MIME-Version: 1.0
Content-type: multipart/mixed; boundary=23xx1211

CRLF

--23xx1211
Content-type: text/html

CRLF

.... html document data.... (first “part” of the message)....
--23xx1211
Content-type: image/jpeg:

CRLF

..... image data ..... (second “part” of the message)....
--23xx1211--

This example illustrates a multipart message that includes two parts: a text file in HTML format and an image file in JPEG format. The MIME “multipart” header indicates that there is more than one component to the message, and specifies the string used to divide the message parts, which in this example “23xx1211”.

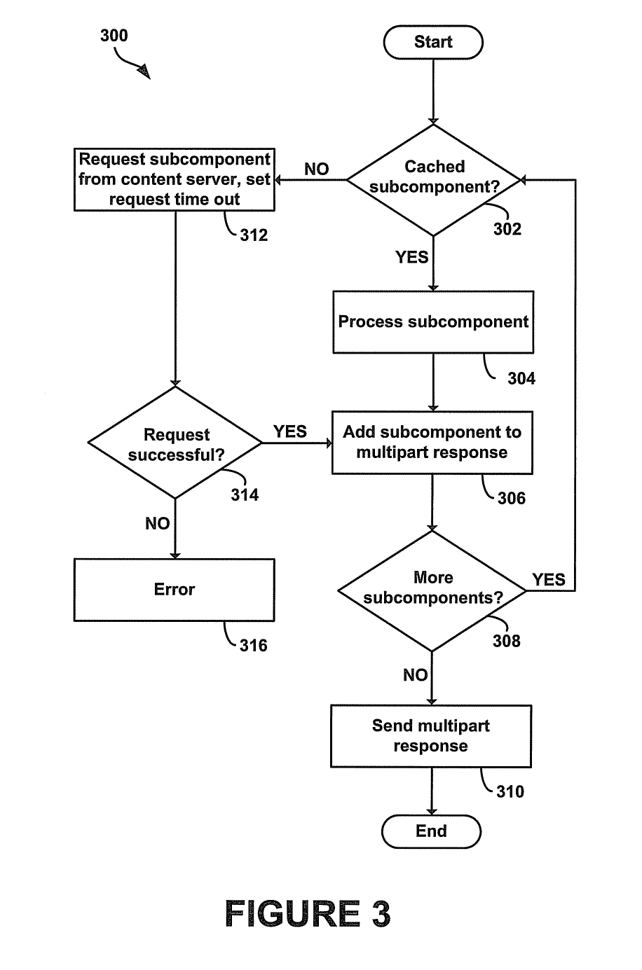

FIG. 3 is a flowchart that depicts example steps of a method 300 for retrieving images information content. The flowchart of FIG. 3 shows functionality and operation of one possible implementation of present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. In addition, each block may represent circuitry that is wired to perform the specific logical functions in the process. Alternative implementations are included within the scope of the example embodiments of the present application in which functions may be executed out of order from that shown or discussed, including substantially concurrent or in reverse order, depending on the functionality involved, as would be understood by those reasonably skilled in the art.

After retrieving a requested HTML document, for each subcomponent referenced in the HTML document, (e.g., each image on the image list 214 as described in FIG. 2), the server will determine if the subcomponent is cached, as shown at block 302. If so, the subcomponent is processed from cache, as shown at block 304, and added to a multipart response message, as shown at block 306. The server then determines if there are more subcomponents referenced in the HTML document, as shown at block 308, and repeats the method 300 until no more subdocuments are needed. At that time, the multipart message is completed and sent to the client device, as shown at block 310.

If the subcomponent is not cached, the server will request the subcomponent from the content server and set a request time-out, as shown at block 312. If the subcomponent is returned within the time-out, at shown at block 314, the server will add the subcomponent to the multipart response message and continue the method. Otherwise, an error occurs, as shown at block 316, and the server may resend the request, for example.

Using multipart messaging as shown in the flow diagram of FIG. 2 and the flowchart of FIG. 3 enables one connection between the client device 202 and the proxy server 204 through which a requested HTML document and all subcomponents of the HTML document may be delivered. However, the server will wait until all subcomponents of a requested HTML document are retrieved prior to bundling and sending the multipart message to the requesting client device.

In example embodiments, the server will retrieve a requested HTML document and request referenced subcomponents until a threshold is reached at which time the server will bundle all retrieved data into a multipart message and send the multipart message to the client device. Using these systems and methods, the device may receive a faster first impression of the web page without a performance delay waiting for all images of the web page to be retrieved and loaded, for example. In addition, a partial set of the subcomponents referenced by a document may be retrieved and returned to the device with the HTML document.

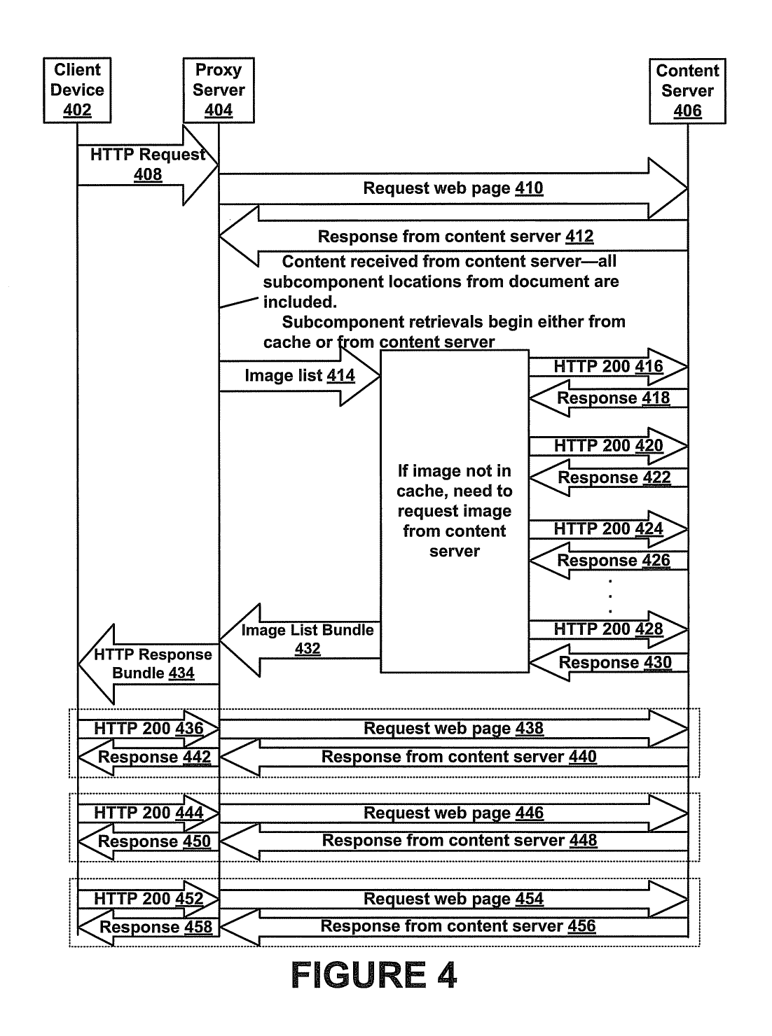

FIG. 4 is an example flow diagram illustrating a method for delivering information to devices using smart multipart messaging. Smart multipart may refer to multipart messaging using constraints to build the multipart documents, for example. Initially, a device 402 makes a request for a website to a proxy server 404, as shown by message 408. The server 404 requests the website from a content server 406, as shown by message 410. The server 404 receives a response including content from the content server 406, as shown at message 412, and will collect subcomponent sources from the HTML document to create a collection of subcomponent objects. The collection of subcomponent objects is organized in a list (e.g., an image list 414) to request all the subcomponents one-by-one when in a multi-image load state, for example. During image retrieval, the server 404 will determine if the image is cached, and if not, will request an image from the content server 406 using an HTTP 200 request, and image data is sent back to the server 404, as shown by messages 416-432. The proxy server 404 will continue to do so until an image request fails, which will occur after a threshold is met, such as an expiration of a timer, a threshold amount of data has been received, or other thresholds. At that time, an HTTP 408 (HTTP Time Out) message is sent to the server 404. Then, an image bundle including all retrieved images during the preset time limit is added to the multipart response by the proxy server 404, and an HTTP response 434 is sent back to the client device 402 with the images data.

If image retrieval was stopped due to expiration of a timer, there might be some images or other subcomponents referenced in the HTML document that were not requested by the proxy server 404 or received by the client device 402. Hence, when the client device 402 parses the HTML code and finds a subcomponent, the client device 402 will look for the subcomponent in the multipart response 434 sent by the proxy server 404. If the subcomponent is not found in the multipart response, then the client device 402 will open another connection with the proxy server 404 for each subcomponent not found and the client device 402 will subsequently request the components. The proxy server 404 might, in turn, request the subcomponents from the content server 406 or from cache. This is depicted in FIG. 4 by messages 436-458.

Thus, using multipart messaging according to example embodiments, constraints are enforced when requesting subcomponents (e.g., images and/or data) of an HTML document so as to request a partial set of the subcomponents referenced by the HTML document. For example, a time (e.g., in milliseconds) can be set as the time limit to retrieve all images. Upon the expiration of the time limit, the multipart response can be sent to the device with as many images as the server retrieved within the time limit. The device will then have to make separate requests for the images not included in the response. The server may follow any number or type of other rules to determine when to stop retrieving information and to send information to the device. For example, the server may retrieve information based on a set of rules including size limitations, time constraints, content types, positioning of the images, etc., or any combination of such constraints. Thus, the server may stop building a multipart document once a time and/or size threshold has been reached.

Since subcomponents are requested in an order as the subcomponents appear in HTML code for the web page(s), and since not all the subcomponents requested may be retrieved (depending on the time limit specified), a first impression of loading of the web page to the user may be faster. For example, instead of waiting to retrieve all subcomponents in a requested webpage, the server will return a multipart message to the requesting device sooner although with possibly less than all subcomponents in the webpage.

In addition, after receiving the information from the content server 406, and prior to sending the information to the client device 402, the proxy server 404 may transcode the information into a format for viewing on the client device 402. In this manner, information retrieval may be accelerated by implementing constraints or thresholds on the retrieval process, and information content can be tailored for viewing on the handheld device.

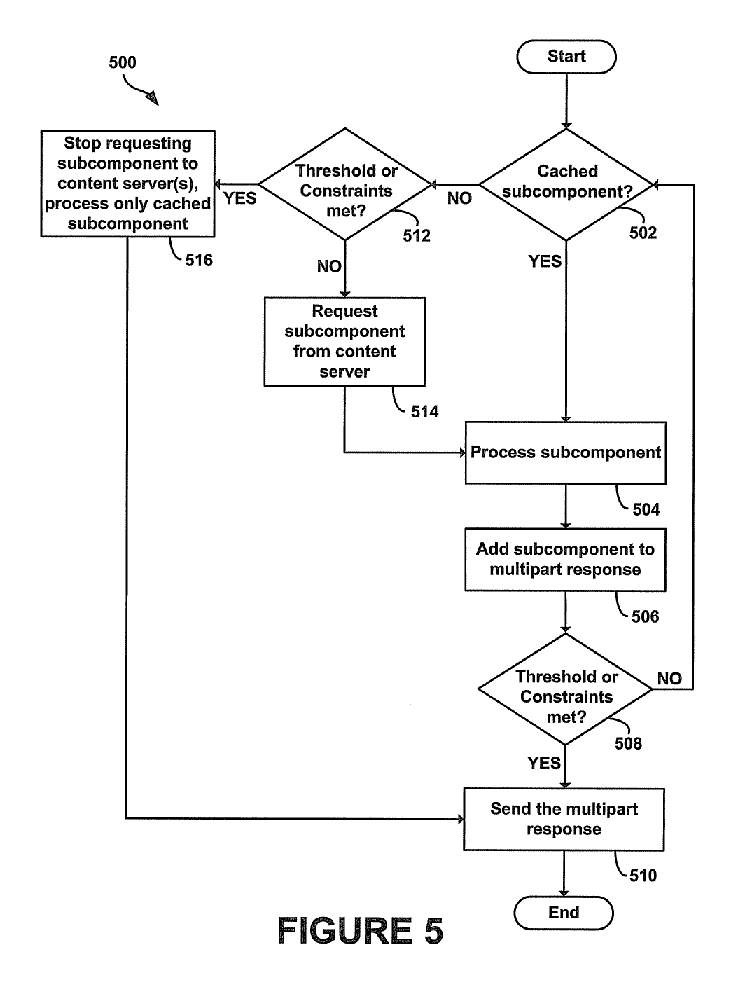

FIG. 5 is a flowchart illustrating an example method 500 for delivering information to devices using smart multipart messaging. The flowchart of FIG. 5 shows functionality and operation of one possible implementation of present embodiments, and each block may represent a module, a segment, or a portion of program code, which includes one or more instructions executable by a processor for implementing specific logical functions or steps in the process, for example.

In the method 500, after receiving an HTML document, for each subcomponent referenced in the HTML document, a server will first determine if the subcomponent is cached, as shown at block 502. Subcomponents of an HTML document may be any type of referenced data or file, such as a cascading style sheet (CSS), Javascript, images, an advertisement (using AJAX to pull in subdocument to show ads themselves), a multimedia file (flash, video component), or any other component that may be bundled on a web page.

If the subcomponent is cached, the subcomponent is processed from cache, as shown at block 504, and the subcomponent is then added to a multipart response, as shown at block 506. Following, the server determines if a threshold or constraint has been reached or satisfied, as shown at block 508. A threshold or constraint may be a time limit, for example, and during this time limit the server will retrieve as many subcomponents as possible.

As another example, the threshold may be a data threshold. For example, the server may continue to retrieve subcomponents until a certain amount of data has been retrieved, at which point the threshold is reached. The threshold may also be based on a percentage of data collected, such as a percentage of subcomponents referenced on a web page or a percentage of data comprising a webpage, so that the server will stop retrieving subcomponents once a certain percentage (e.g., about 25%, about 50%, etc.) has been retrieved. The threshold may further include a number of sub-requests performed by the server to retrieve subdocuments, so that the server will stop retrieving subcomponents once a certain number of subcomponents have been requested and/or received (such as, e.g., 10, 20, or 50).

In addition, the threshold may be any combination of such constraints, such as a time limit and a data constraint, and when either is met, the server stops retrieving subcomponents. Still further, the threshold may depend on how much data has been retrieved so that at least a certain amount has been retrieved that can be sent to the device to render an acceptable representation of the web page on the device. In this example, a data threshold may override a time limit threshold.

The threshold may also be a data specific threshold. For example, if the HTML document has subcomponents including images, the threshold may indicate that at least the first image, or the first 5, 10, etc., number of images is to be requested and/or received, and thus, this threshold may override a time limit threshold. Using this threshold, a viewer of the information content sent to the device may view at least a portion of the information content with images. However, if the HTML document does not include image subcomponents, this threshold may be ignored.

A further threshold or constraint may be set to not retrieve any subcomponents and only to return text (e.g., the HTML document) to the client device, for example. To do so, a time limit of zero seconds can be set in which to request and retrieve subdocuments referenced by the HTML document. The HTML document may be returned to the device as a text document (via a transcoding process used by the proxy server 404), or the HTML document may be returned with text and placeholders for images, media files, etc., where information pertaining to the subdocuments of the HTML document would be displayed, for example.

The server may set priorities to thresholds to indicate that at least a certain amount of data is to be retrieved, for example, before a response can be sent so as to override a time limit threshold. The thresholds may further be set by a client device based on preferences of users of the client device. For example, if a user has a preference to view requested information as fast as possible, a short time limit may be set to override any other thresholds. Alternatively, if a user has a preference to at least a certain amount of a web page (e.g., a top portion) so as to provide a meaningful representation of the webpage, a data limit may be set to override a time limit.

Returning back to FIG. 5, if the threshold has been met, the server sends the multipart response to the device, as shown at block 510. If the threshold has not been met, the server repeats the method 500 to retrieve a next subcomponent referenced in the HTML document.

When a subcomponent is not cached, the server will check to see if the threshold is met, as shown at block 512, and if not, the server requests the subcomponent from the content server as shown at block 514. If the threshold has been met, the server stops requesting subcomponents from the content server(s), and processes only cached subcomponents, as shown at block 516.

Using the method 500 in FIG. 5, the server gathers as many subcomponents as possible under the thresholds, and sends the multipart response message to the device. In a specific example, if a webpage references fifty images, includes a Javascript file, and a media file, and if the threshold has been set to only make 20 subrequests, then the server will only be able to retrieve the first 20 subcomponents (e.g., the first 20 images), and return the HTML document including the first 20 images to the client device. The client device will determine that the HTML document references more subcomponents, and the client device will follow up as needed with the server to receive the other subcomponents. In this manner, the client device can decide whether to perform additional requests for remaining subcomponents.

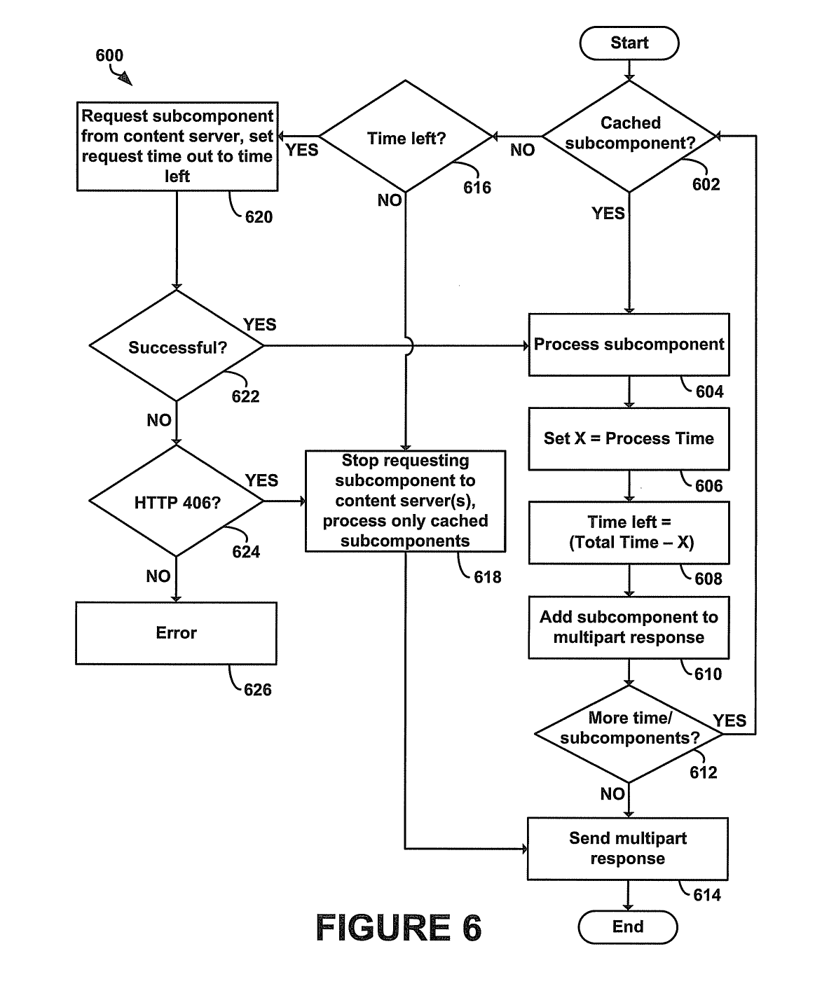

FIG. 6 is a flowchart illustrating another example method 600 for delivering information to devices using smart multipart messaging where a threshold is a time limit. The flowchart of FIG. 6 shows functionality and operation of one possible implementation of present embodiments, and each block may represent a module, a segment, or a portion of program code, which includes one or more instructions executable by a processor for implementing specific logical functions or steps in the process, for example.

In the method 600, after receiving an HTML document, for each subcomponent referenced in the HTML document, a server will first determine if the subcomponent is cached, as shown at block 602. If so, the subcomponent is processed from cache, as shown at block 604, and a time (“X”) to process the image is determined, as shown at block 606. A timer is then set to a time left of “Total Time” less “X” (from above), as shown at block 608. The subcomponent is then added to the multipart response, as shown at block 610, and the server continues to retrieve a next subcomponent if there are more subcomponents and more time remaining, as shown at block 612. If there are no more subcomponents to retrieve, or if the timer has expired, then the server sends the multipart response message to the device, as shown at block 614.

Thus, prior to beginning to retrieve a next subcomponent, the server determines if the timer has expired, as shown at block 616. If so, the server stops requesting images and processes all cached images, as shown at block 618.

If the timer has not yet expired, then the server requests subcomponents from the content server and resets the timer accordingly, as shown at block 620. If the timer expires, the server will receive an HTTP 408 (Time Out) message, as shown at blocks 622 and 624, at which point the server stops image retrieval from the content server. If an error occurs, as shown at block 626, the server may attempt to retrieve the subcomponent again. The server may then bundle up all retrieved images and send the bundle with the document to the client device.

Every time a subcomponent is requested from a content server, a time-out in milliseconds may be specified, and if the content server has not responded within the time-out period, an HTTP 408 (time-out) error is thrown, for example. A default time-out may be about 2,000 ms. If smart multipart is disabled, every image request may have the same time-out period. However, if smart multipart is enabled, the first image to be requested will have the time-out set to a time limit as specified in the smart multipart settings. As another example, when the smart multipart is enabled, and the timer is set to 0 ms, the server will only send cached images in a multipart response to the device since the server has no time to make requests for non-cached images.

Thus, when smart multipart is enabled, the request for a website comes into the server. The server sends a multipart response to the device and some subcomponents may be missing since the subcomponents were not loaded within the time limit specified. The subcomponents that are missing are then requested by the device to the server, and the server subsequently requests the subcomponents from the content server and caches the subcomponents before sending the images to the device.

Upon a first page request, the cache in the device may be cleared and the cache in the server may be cleared as well. The page can then be loaded, and a time for a first impression (e.g., when the device begins to display something on the screen), a time for a first complete look (e.g., when the device displays everything that is visible on the screen, including images), and a total load time (time when entire page is loaded) can be determined and compared to determine if the smart multipart messaging has been a benefit for a device.

As a specific example, if a 2,000 ms time limit is, then the server has 2,000 ms to request all subcomponents of an HTML document. If a page being requested has 10 images, the image retrieval may be:

Image 1 → Request Image 1, set time-out period to 2,000 ms.
Image 1 took 500 ms to be requested and processed.
Image 2 → Request Image 2, set time-out period to 2,000 ms − 500 ms =
1,500 ms.
Image 2 took 500 ms to be requested and processed.
Image 3 → Request Image 3, set time-out period to 1,500 ms − 500 ms =
1,000 ms.
Image 3 took 500 ms to be requested and processed.
etc., etc., etc . . .

At some point, the server will either request all the images within the time limit specified or an HTTP error message (time out) will be thrown. If the case is the latter (HTTP error message or flag is thrown), then the server will stop making requests to content server(s) and will only load images that have been retrieved thus far. The web page may be loaded with empty image placeholders for any images that were not returned in time.

The server may be capable of delivering web pages, adapted for display on a handheld device, using MIME Multipart support in compliance with the requirements in RFC 2045 and RFC 2387, the entire contents of both of which are herein incorporated by reference.

According to example embodiments, the server will retrieve the page, start to retrieve images, and do so for a limited amount of time, and then send all retrieved information to the device. The device will then render the received information, using a browser, and determine if any information is missing. If so, the device will make subsequent requests for the missing information.

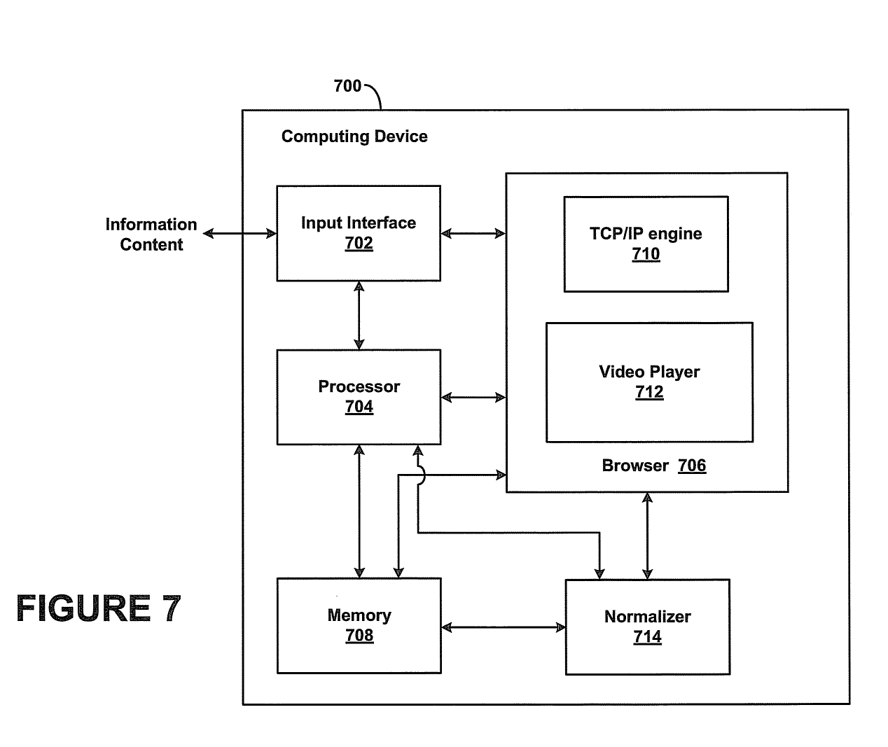

FIG. 7 illustrates a block diagram of an example computing device 700 that may operate according to example embodiments, such as to perform smart multipart messaging or real-time aggregating of content into a single multipart response in such a way that a user may receive information more quickly. In one example, the computing device 700 may operate as a server, as shown in FIG. 1. The computing device 700 receives information content at an input interface 702. The information content may be received from an information source, or from an intermediate proxy server, for example. The information content may be in the form of website data, and may be transcoded for viewing on a client device, or alternatively, may be received in a native form and can be transcoded (if needed) by the computing device 700.

The input interface 702 connects to a processor 704 and a browser 706. The processor 704 may process data and control functionality of components in the computing device 700. The processor 704 may be embodied as a processor that accesses memory 708 to execute software functions stored therein. One skilled in the art of computer systems design will understand that the example embodiments are not limited to any particular class or model of processor. The processor 704 may operate according to an operating system, which may be any suitable commercially available embedded or disk-based operating system, or any proprietary operating system. Further, the processor 704 may comprise one or more smaller central processing units, including, for example, a programmable digital signal processing engine or may also be implemented as a single application specific integrated circuit (ASIC) to improve speed and to economize space. In general, it should be understood that the processor 704 could include hardware objects developed using integrated circuit development technologies, or yet via some other methods, or the combination of hardware and software objects that could be ordered, parameterized, and connected in a software environment to implement different functions described herein. Also, the hardware objects could communicate using electrical signals, with states of the signals representing different data.

The memory 708 may store information such as previously transmitted or received signals, for example. The memory 708 may include random access memory (RAM), flash memory or long term storage, such as read only memory (ROM) or magnetic disks, for example. The memory 708 may store machine language instructions that are executable by the processor 704 to execute functions as described herein (e.g., such as the methods shown in FIGS. 2-6).

The browser 706 may include a TCP/IP engine 710. The browser 706 may receive the information content and prepare the information content for display. To do so, the browser 706 may format the information content as needed, such as by transcoding the content for display on a handheld device. In this regard, the browser 706 may operate as a server browser to transcode the information content to be sent to a client device. Alternatively, the browser 706 may operate as a client browser with full functionality for transcoding the information content upon receipt of the content from a server, for example. Or, the browser 706 may have limited functionality as a client browser and may receive the information content and display the content in the form received, for example.

The TCP/IP engine 710 operates to receive and send requests for information content. The computing device 700 can be operated by the processor 704 to convert information content into a form accessible by a requesting client device. For example, a client device may request a typical web page, and thus the computing device 700 will access the Internet and retrieve the requested web page and then the browser 706 can convert the web page into a form accessible by the client device. In some instances, the web page will include video, movie, or flash player content, and thus the computing device 700 will retrieve and load the web page on the browser 706 using a video player 712. The browser 706 can then modify the web page or video content as needed, and send the modified content to a client device.

The computing device 700 may further include a normalizer 714, or as a component of the processor 704 or browser 706. The normalizer 714 may be operated to transform or transcode information content into a format for display on a client device, for example.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for delivering information content to a device, comprising:
receiving a request from a device for information content from a webpage;
retrieving a document associated with the webpage, the document including references to subcomponents;
based on a constraint, requesting from a content server a partial set of the subcomponents referenced by the document; and
sending the document and the partial set of the subcomponents received from the content server to the device in a single response.

2. The method of claim 1, further comprising receiving from the device subsequent requests for subcomponents referenced by the document and not received by the device.

3. The method of claim 1, wherein sending the document and the partial set of subcomponents received from the content server to the device comprises sending a Multipurpose Internet Mail Extension (MIME) multipart message.

4. The method of claim 1, wherein the document is an HTML document.

5. The method of claim 1, wherein the subcomponents include information content selected from the group consisting of a cascading style sheet (CSS), Javascript, images, and a multimedia file.

6. The method of claim 1, further comprising determining if any of the subcomponents are previously cached.

7. The method of claim 6, wherein the constraint indicates to only send cached subcomponents with the document to the device.

8. The method of claim 1, wherein the constraint includes a time limit, and wherein requesting from the content server the partial set of the subcomponents referenced by the document comprises requesting the subcomponents in an order referenced on by the document until expiration of the time limit.

9. The method of claim 1, wherein the constraint includes a data limit, and wherein requesting from the content server the partial set of the subcomponents referenced by the document comprises requesting the subcomponents in an order referenced on by the document until receipt of data comprising the data limit.

10. The method of claim 1, further comprising requesting from the content server the partial set of the subcomponents referenced by the document until a percentage of subcomponents referenced by the document have been requested.

11. The method of claim 1, wherein the constraint includes a number of subcomponents, and wherein requesting from the content server the partial set of the subcomponents referenced by the document comprises requesting the subcomponents in an order referenced on by the document until receipt of the number of subcomponents.

12. The method of claim 1, wherein the constraint includes a data limit and a time limit, and wherein requesting from the content server the partial set of the subcomponents referenced by the document comprises requesting the subcomponents in an order referenced on by the document until receipt of data comprising the data limit or until expiration of the time limit.

13. The method of claim 12, wherein the data limit overrides the time limit such that requesting from the content server the partial set of the subcomponents referenced by the document comprises requesting the subcomponents at least until receipt of data comprising the data limit.

14. The method of claim 1, wherein the constraint includes a set of constraints and wherein priorities are set for each constraint in the set of constraints, and wherein requesting from the content server the partial set of the subcomponents referenced by the document comprises requesting the subcomponents based on the set of constraints and according to the priority of each constraint.

15. The method of claim 1, further comprising prior to sending the document and subcomponents received from the content server to the device, transcoding the documents and the subcomponents into a format displayable on the device.

16. The method of claim 1, wherein the constraint includes a data specific threshold, and wherein requesting from the content server the partial set of the subcomponents referenced by the document comprises requesting the subcomponents until a predetermined amount of a type of data is obtained.

17. A computer readable medium having stored therein instructions executable by a computing device to cause the computing device to perform functions of:
receiving a request from a device for information content from a webpage;
retrieving a document associated with the webpage, the document including references to subcomponents;
based on a constraint, requesting from a content server a partial set of the subcomponents referenced by the document; and
sending the document and the partial set of the subcomponents received from the content server to the device in a single response.

18. The computer readable medium of claim 17, wherein the constraint includes a time limit, and wherein the function of requesting from the content server the partial set of the subcomponents referenced by the document comprises requesting the subcomponents in an order referenced on by the document until expiration of the time limit.

19. The computer readable medium of claim 17, wherein the constraint includes a data limit, and wherein the function of requesting from the content server the partial set of the subcomponents referenced by the document comprises requesting the subcomponents in an order referenced on by the document until receipt of data comprising the data limit.

20. The computer readable medium of claim 17, wherein the constraint includes a data limit and a time limit, and wherein the function of requesting from the content server the partial set of the subcomponents referenced by the document comprises requesting the subcomponents in an order referenced on by the document until receipt of data comprising the data limit or until expiration of the time limit.

21. A server comprising:
a processor;
memory including machine language instructions executable by the processor to perform functions comprising:
receiving a request from a device for information content from a webpage;
retrieving a document associated with the webpage, the document including references to subcomponents;
based on a constraint, requesting from a content server a partial set of the subcomponents referenced by the document; and
a normalizer for transcoding the document and the partial set of the subcomponents received from the content server into a format displayable on the device, wherein the normalizer sends the transcoded document and the partial set of the subcomponents to the device in a single response.

22. The server of claim 21, wherein the constraint includes a time limit, and wherein the function of requesting from the content server the partial set of the subcomponents referenced by the document comprises requesting the subcomponents in an order referenced on by the document until expiration of the time limit.

23. The server of claim 21, wherein the constraint includes a data limit, and wherein the function of requesting from the content server the partial set of the subcomponents referenced by the document comprises requesting the subcomponents in an order referenced on by the document until receipt of data comprising the data limit.
